(19) United States
(12) Patent Application Publication
(10) Pub. No.: US 2006/0140171 A1
(43) Pub. Date: Jun. 29, 2006

(54) Method and apparatus for enabling the network to disconnect unintentionally idle off-hook endpoints

(76) Inventors: Marian Croak, Fair Haven, NJ (US); Hossein Eslambolchi, Los Altos Hills, CA (US)

Correspondence Address: AT&T CORP., ROOM 2A207, ONE AT&T WAY, BEDMINSTER, NJ, 07921, US

(21) Appl. No.: 11/023,093

(22) Filed: Dec. 27, 2004

(51) Int. Cl. H04L 12/66; H04L 12/56

(52) U.S. Cl. 370/352; 370/401

(57) ABSTRACT

The present invention enables a packet-switched network service provider, e.g., a VoIP network service provider, to periodically check the status of all registered endpoints and keep state information about them for a specified period of time. Phones that are off-hook and have been idle for some specified period of time will be placed on-hook by the network as a courtesy to the registered user.

The present invention relates generally to communication networks and, more particularly, to a method and apparatus for enabling the network to disconnect unintentionally idle off-hook endpoints in packet-switched networks, e.g., Voice over Internet Protocol (VoIP) networks.

### BACKGROUND OF THE INVENTION

Cordless phones are designed so that users have to press a button to disconnect the line after a conversation has ended. Users sometimes neglect to do this and the phone remains off-hook and appears to be in a busy state and unable to receive incoming calls for as long as it takes the user to recognize that the phone remains off-hook. During this period of time, the phone cannot receive incoming calls at all.

Therefore, a need exists for a method and apparatus for enabling the network to disconnect unintentionally idle off-hook endpoints in packet-switched networks, e.g., VoIP networks.

### SUMMARY OF THE INVENTION

In one embodiment, the present invention enables a packet-switched network service provider, e.g., a VoIP network service provider, to periodically check the status of all registered endpoints and keep state information about them for a specified period of time. Phones that are off-hook and have been idle for some specified period of time will be placed on-hook by the network as a courtesy to the registered user.

### BRIEF DESCRIPTION OF THE DRAWINGS

The teaching of the present invention can be readily understood by considering the following detailed description in conjunction with the accompanying drawings, in which:

FIG. 1 illustrates an exemplary Voice over Internet Protocol (VoIP) network related to the present invention;

FIG. 2 illustrates a flowchart of a method for enabling the network to disconnect unintentionally idle off-hook endpoints in a VoIP network of the present invention; and

FIG. 3 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

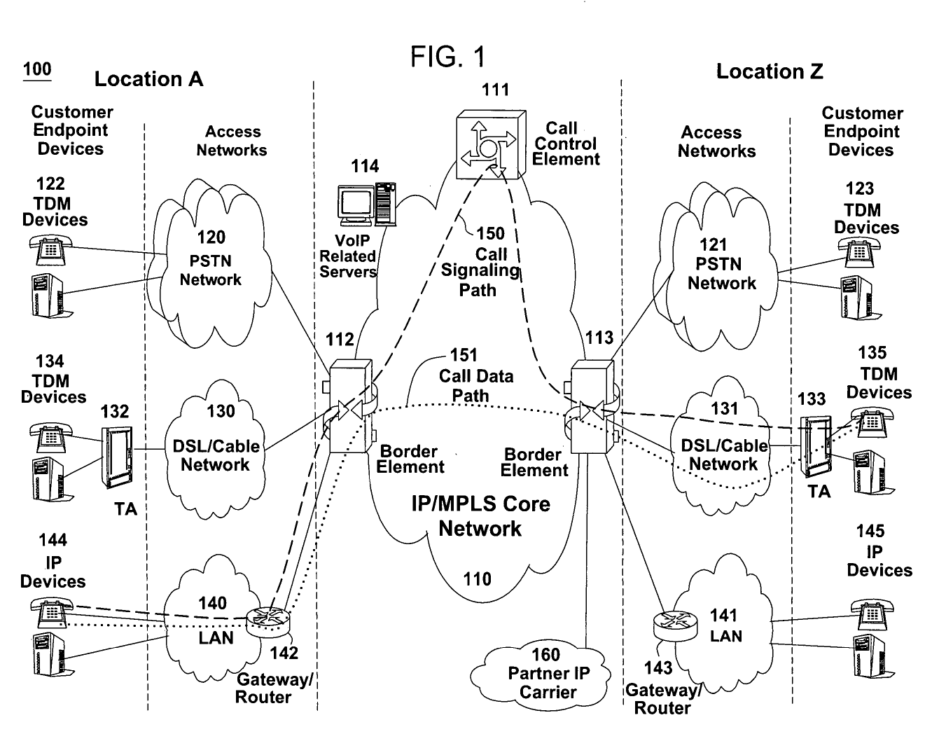

To better understand the present invention, FIG. 1 illustrates an example network, e.g., a packet-switched network such as a VoIP network related to the present invention. The VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. An IP network is broadly defined as a network that uses Internet Protocol to exchange data packets.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, and VoIP related servers 114. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related servers in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related server 114 to obtain the information to complete this call. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, a call acknowledgement signaling message, such as a SIP-ACK message if SIP is used, is sent in the reverse direction back to the CCE 111. After the CCE 111 receives the call acknowledgement message, it will then send a call acknowledgement signaling message, such as a SIP-ACK message if SIP is used, toward the calling party. In addition, the CCE 111 also provides the necessary information of the call to both BE 112 and BE 113 so that the call data exchange can proceed directly between BE 112 and BE 113. The call signaling path 150 and the call data path 151 are illustratively shown in FIG. 1. Note that the call signaling path and the call data path are different because once a call has been setup up between two endpoints, the CCE 111 does not need to be in the data path for actual direct data exchange.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

Cordless phones are designed so that users have to press a button to disconnect the line after a conversation has ended. Users sometimes neglect to do this and the phone remains off-hook and appears to be in a busy state and unable to receive incoming calls for as long as it takes the user to recognize that the phone remains off-hook. During this period of time, the phone cannot receive incoming calls at all.

To address this criticality, the present invention enables a VoIP network service provider to periodically check the status of all registered endpoints and keep state information about them for a specified period of time. Phones that are off-hook and have been idle for some specified period of time will be placed on-hook by the network as a courtesy to the registered user.

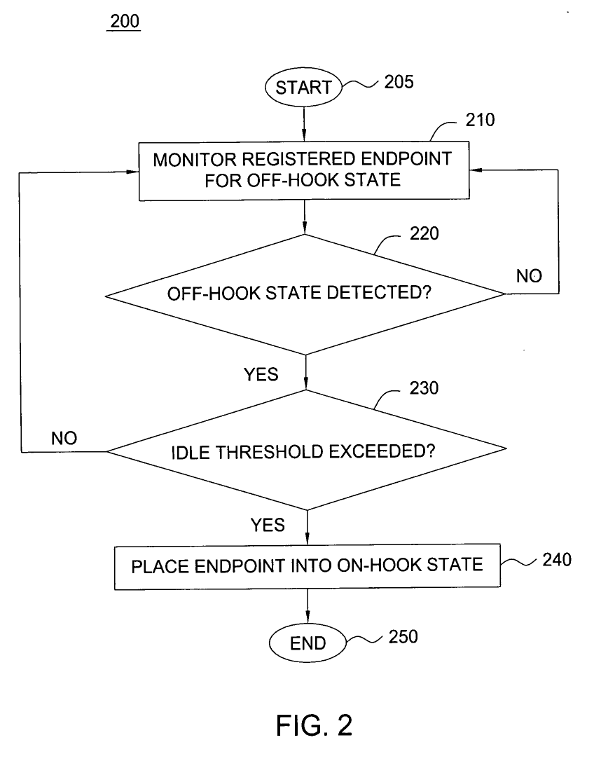

FIG. 2 illustrates a flowchart of a method for enabling the network to disconnect unintentionally idle off-hook endpoints in a packet switched network, e.g., a VoIP network. Method 200 starts in step 205 and proceeds to step 210.

In step 210, the method monitors a registered endpoint to detect off-hook state. It is presumed that the endpoint has registered for a disconnecting service for unintentionally idle off-hook endpoint. Namely, the network only monitors those endpoints of subscribers to the service.

In step 220, the method checks if an off-hook state is detected. In one embodiment, a BE is used to detect the off-hook state of an endpoint. If an off-hook state is detected, the method proceeds to step 230; otherwise, the method proceeds back to step 210. In step 230, the method checks how long the endpoint has been idle. If the idle time has exceeded the predefined threshold that is configured by the network provider, the method proceeds to step 240; otherwise, the method proceeds back to step 210. In step 240, the method places the off-hook endpoint into the on-hook state, e.g., by a BE of the network. In one embodiment, the network sends the endpoint a predefined signaling message to place the phone into the on-hook state. The method ends in step 250.

The present invention applies to cordless phone or any Internet Protocol (IP) based phones. Specifically, in one embodiment, the cordless phone or the Internet Protocol (IP) based phone has the ability to recognize the predefined signaling message from the communication network to place the phone into the on-hook state.

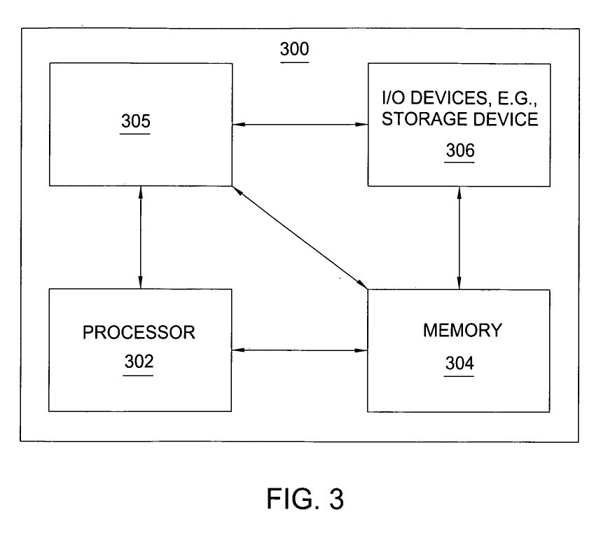

FIG. 3 depicts a high level block diagram of a general purpose computer suitable for use in performing the functions described herein. As depicted in FIG. 3, the system 300 comprises a processor element 302 (e.g., a CPU), a memory 304, e.g., random access memory (RAM) and/or read only memory (ROM), a disconnecting module 305, and various input/output devices 306 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present disconnecting module or process 305 can be loaded into memory 304 and executed by processor 302 to implement the functions as discussed above. As such, the present disconnecting process 305 (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for enabling the network to disconnect unintentionally idle off-hook endpoint in a communication network, comprising:
detecting said endpoint being in an off-hook state;
determining whether said endpoint has been in said off-hook state greater than a predefined threshold; and
placing said endpoint in an on-hook state if said predefined threshold has been exceeded.

2. The method of claim 1, wherein said communication network is a Voice over Internet Protocol (VoIP) network.

3. The method of claim 1, wherein said off-hook state is detected by a border element (BE).

4. The method of claim 1, wherein said endpoint is an endpoint that has registered for a disconnecting service for unintentionally idle off-hook endpoint.

5. The method of claim 1, wherein said predefined threshold is a configurable parameter.

6. The method of claim 1, wherein said endpoint is placed into said on-hook state by a border element (BE).

7. A computer-readable medium having stored thereon a plurality of instructions, the plurality of instructions including instructions which, when executed by a processor, cause the processor to perform the steps of a method for enabling the network to disconnect unintentionally idle off-hook endpoint in a communication network, comprising:
detecting said endpoint being in an off-hook state;
determining whether said endpoint has been in said off-hook state greater than a predefined threshold; and
placing said endpoint in an on-hook state if said predefined threshold has been exceeded.

8. The computer-readable medium of claim 7, wherein said communication network is a Voice over Internet Protocol (VoIP) network.

9. The computer-readable medium of claim 7, wherein said off-hook state is detected by a border element (BE).

10. The computer-readable medium of claim 7, wherein said endpoint is an endpoint that has registered for a disconnecting service for unintentionally idle off-hook endpoint.

11. The computer-readable medium of claim 7, wherein said predefined threshold is a configurable parameter.

12. The computer-readable medium of claim 7, wherein said endpoint is placed into said on-hook state by a border element (BE).

13. A system for enabling the network to disconnect unintentionally idle off-hook endpoint in a communication network, comprising:
means for detecting said endpoint being in an off-hook state;
means for determining whether said endpoint has been in said off-hook state greater than a predefined threshold; and
means for placing said endpoint in an on-hook state if said predefined threshold has been exceeded.

14. The system of claim 13, wherein said communication network is a Voice over Internet Protocol (VoIP) network.

15. The system of claim 13, wherein said off-hook state is detected by a border element (BE).

16. The system of claim 13, wherein said endpoint is an endpoint that has registered for a disconnecting service for unintentionally idle off-hook endpoint.

17. The system of claim 13, wherein said predefined threshold is a configurable parameter.

18. The system of claim 13, wherein said endpoint is placed into said on-hook state by a border element (BE).
